(19) United States
(12) Patent Application Publication
(10) Pub. No.: US 2011/0137734 A1
(43) Pub. Date: Jun. 9, 2011

(54) Methods of Branding Through Educational Media and Related Computer & Software Platforms

(76) Inventor: Mykalai Kontilai, Las Vegas, NV (US)

(21) Appl. No.: 12/960,494

(22) Filed: Dec. 4, 2010

Related U.S. Application Data
(60) Provisional application No. 61/266,875, filed on Dec. 4, 2009.

(51) Int. Cl. G06Q 30/00; G06Q 50/00

(52) U.S. Cl. 705/14.72; 705/310; 705/26.3; 705/26.1

(57) ABSTRACT

Disclosed is a new method and related applications for the national, and global branding of multi-dimensional business models through the process and use of productions of educationally based media programs where there is not a clear “call to action” or advertisement. The educational media programs employed are those featuring topics of interest to adult audiences, and branding is solidified as a result of goodwill and developing trust with the public. Subsequent to a goodwill building stage, commercial exploitation of said brand commences by a variety of methods including through the use of software and computing means.

### CROSS-REFERENCE TO RELATED APPLICATIONS

This application claims the priority of U.S. Prov. Pat. App. 61/266,875 (filed Dec. 4, 2009) entitled “Methods of Branding Through Educational Media and Related Computer 86 Software Patforms,” and said provisional application is hereby incorporated by reference.

### STATEMENT REGARDING FEDERALLY SPONSORED RESEARCH OR DEVELOPMENT

Not applicable.

### BACKGROUND OF THE INVENTION

1. Field of Invention

The present application is in the field of methods, including computerized applications and methods, for branding goods or services.

2. Background of the Invention

Typically, goodwill is built for name brands via commercially advertising the goods or services associated with the corresponding brand. Direct advertising is typically expensive, and comprises biased, subjective, and self-serving statements regarding the quality of the associated goods or services made by those with a vested interest in the success of the underlying name brand. Very frequently, traditional advertisements for a product or brand will entail a “call to action” where the consumer is asked to take a decisive action to purchase the product or service. In other circumstances, branding may work through testimonials, endorsements by celebrities, or prominent displays in theatrical or television shows. This method of direct advertising is the core of advertising and has been for some time. However, there are problems with traditional advertising methods in the development of brand identity, even beyond the shear cost of the traditional methods. With the advent of digital video recording technologies, and increasingly shorter attention spans, many consumers have an adverse reaction to traditional advertising mechanisms which may be perceived as annoying and invasive. Thus, what is needed is a departure from traditional mechanisms of branding and one that may be implemented, and developed, including by computer means.

### SUMMARY OF THE INVENTION

Thus, disclosed is a new method and related applications for the national, and global branding of multi-dimensional business models through the process and use of productions of educationally based television programs where there is not a clear “call to action” or advertisement. The educational television programs employed are those featuring topics of interest to adult audiences, and branding is solidified as a result of goodwill and developing trust with the public.

Accordingly, it is an object of the present invention to provide a method for branding, that is not as expensive as direct advertising.

It is yet another object of the present invention to provide a method of branding that depends on objective statements regarding the quality of the associated goods or services.

More specifically, it is the object of the present invention to provide a method of branding that depends on objective statements from experts regarding the quality of the associated goods or services, made in the context of educational television, radio, or internet programming.

It is still a further object of the present invention to provide a method of branding through the production of worldwide educationally based television, radio, or internet programming, and where computer means and software applications are intended to facilitate the branding methods.

It is still another object of the present invention to provide a method of branding that also provides a legitimate public service.

It is still another object of the present invention to provide a method of branding that appeals to consumers who value and identify with community-based social ideologies.

It is still another object of the present invention to provide branding through programming where advertising is not permitted, and that does not spin off of existing programs.

It is still another object of the present invention to employ methods where the name of the brand developed corresponds to the name of a particular show being produced.

It is yet another object of the present invention to use computer means and software applications in association with the branding methods.

### BRIEF DESCRIPTION OF THE FIGURES

Other objectives of the invention will become apparent to those skilled in the art once the invention has been shown and described. The manner in which these objectives and other desirable characteristics can be obtained is explained in the following description and attached figures in which:

FIG. 1 is a flow chart describing preferable logic flows related to preferable features and steps to the invention.

FIG. 2 is a flow chart describing preferable logic flows related to additional preferable features and steps to the invention.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

In general, the method of branding presently disclosed involves developing good-will and public trust for the associated goods and services via the production and broadcast of worldwide educationally based television, radio, or internet programs. The program title will preferably be the brand name. The program will preferably target adult audiences and comprise educational content and themes related to the goods or services associated with the brand. Ultimately, the programming will be provided via educationally based air time PTV, public access, educational cable, educational websites, and the like.

The educational content of the programming is preferably presented by at least one unique expert who objectively evaluates the merits of the goods or services associated with the subject brand in the context of the educational topic. Preferably, the experts will also discuss the relationship of the subject brand to the viewing community's social ideologies. Presentation of the content will accomplish, in some way, a public service rather than a mere solicitation or call to take actions relating to the subject brand. By way of example, a program relating to the collection of memorabilia and antiquities might feature a PhD in a relevant field, such as history. Whereas, a program about medical developments might feature a M.D. who could advise the viewing public of various aspects of the programming that would be of interest to the viewer. The expert assists the viewer to establish a rapport with the viewers, and brand identification with the television show.

The programming and the associated content should preferably exclude all ordinary types of direct commercial advertising. Although the experts will discuss the products and services associated with the subject brand, paid-for product placement is preferably not allowed. Moreover, the program will preferably not be followed with a call-center, 1-800-number, or request to buy anything. Furthermore, the content is preferably not a spin-off from existing programming. On the contrary, the content is preferably based on original content.

As mentioned above, the programming content should preferably target adult audiences. Moreover, the programming content may not be associated with or directed to viewing audiences who are young children. There are a variety of children's educational programs, such as Sesame Street or the Electric Company, however, unlike those endeavors, the current presentations are directed towards more mature audiences. Also, an important motivation to the current methods is to employ educational television, and other media, with product branding.

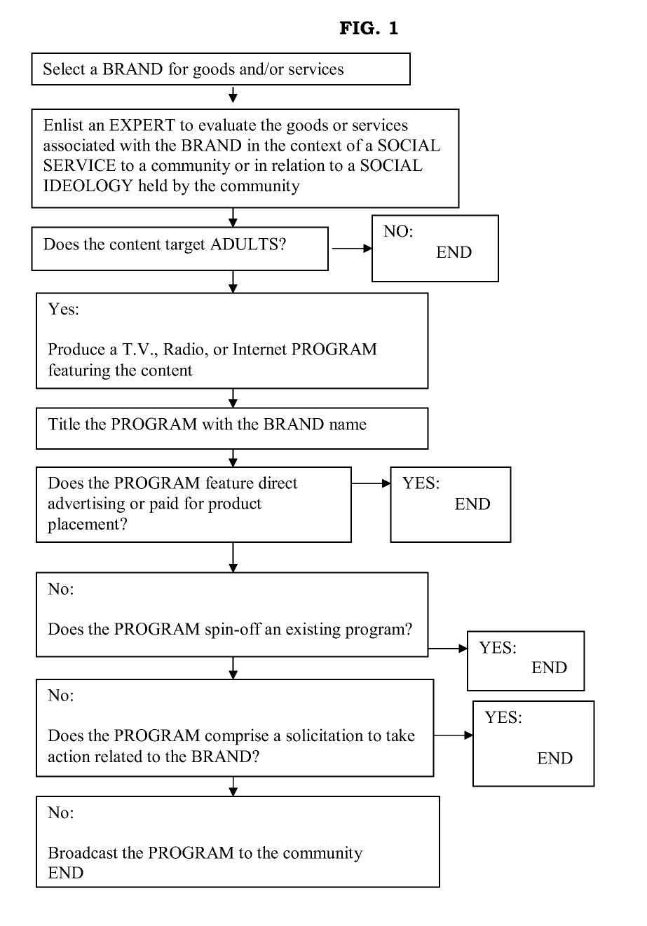

Now turning to a detailed description of FIG. 1, preferable steps of a method are discussed. These flows of logic, and the related methods, may be implemented and facilitated with the assistance and on computer means and with software applications that may be programmed with any variety of computer languages, including but not limited to C++, Java, 4GLS, Perl, and a variety of other languages that are known in the art of programming to track the logic of a particular logic pattern. It should also be noted that variations on the arrangements of logic are preferable. In a preferable first step, the method(s) involve selection of a brand for goods or services. The brand is typically a word mark, or logo, as would be familiar to those in advertising. In some instances, databases would be consulted to verify the availability of a particular mark or logo with national and/or international authorities for registration on a trademark database. The brand would typically be targeted for specific goods or services. Thereafter brand selection, a user of the method would enlist an expert to evaluate the goods or services associated with the brand. The expert is typically selected because of his or her ability to associate the brand in the context of a social service to an identifiable community, and in many instances to social beliefs and ideologies that may be held by that particular community. For instance, an expert in the field of collectibles might be an individual responsible for valuation of collectibles and avoiding fraud. Thus, the expert is used to teach a social service and establish trust and goodwill with the consuming public. The application typically ascertains that the target audience is for adults, or at least not to young children. The expert identified is affiliated with a next step in the method, namely, that of producing a radio, television, podcast, phonecast, or internet program featuring the educational content of the aforementioned identified brands. The expert is used in conjunction with broadcasts thereof. An important feature of this method is also to title the program that is to be broadcast with the brand name. In this manner, the goodwill of the program from the educational broadcast is associated with the identified brand in the eyes of the consuming public. Various checks are associated with the method to ensure that the program does not feature paid advertising; does not spin off of an existing program, and that the programming is geared to age-appropriate consumer bases.

Subsequent to the development of goodwill, a particular user of the disclosed methods may take the brand, which has been developed through public media and goodwill, and harness the brand for commercial gain. It is understood that there may be a considerable lag time between production of the educational broadcasts, development of the goodwill, and subsequent exploitation of a brand. In some cases this may be weeks, but in others it could be years. Goodwill is a process that involves trust, time, and offering a legitimate educational service to the public. However, nothing is sold on or through the broadcasts directly at the goodwill developing stage. Those skilled in the arts of marketing will appreciate how value may be realized, and commercial gain attained with a valuable brand thereafter. In some instances, there may be value to having certifications by an established brand that is associated with quality and honesty. Paintings, for instance, could be certified with a developed brand, giving enhanced value to the underlying merchandise. Merchandising, licensing, and/or franchising with a particular brand may also happen subsequent to branding development, but still never during the actual educational broadcasts which benefit the consumer.

As mentioned above, commercial exploitation is not accomplished during the period of educational broadcasts. Rather, after sufficient goodwill has been created in the brand, the brand name may be subequently exploited via franchising, mass grocery and retail, licensing, or e-commerce. For example, an educational program for the collection of memorabilia and antiquities might generate goodwill for a brand name associated with an sports memorabilia dealer, whereafter generating the goodwill the owner of the goodwill and brand may earn revenues by methods which include, but are not limited to: (1) franchising the brand and exploiting the goodwill via franchising fees, (2) selling collectibles via mass grocery or retail stores bearing the brand name, (3) selling collectibles in e-commerce (whether by online auction, live auction, or simple retail) under the developed brand name; (4) licensing use of the brand on goods or services; (5) developing community websites under the brand and harnessing paid advertising revenues in connection therewith; (6) using the brand in product placements, movies, and with other assorted rights that will be appreciated by those in the advertising industry.

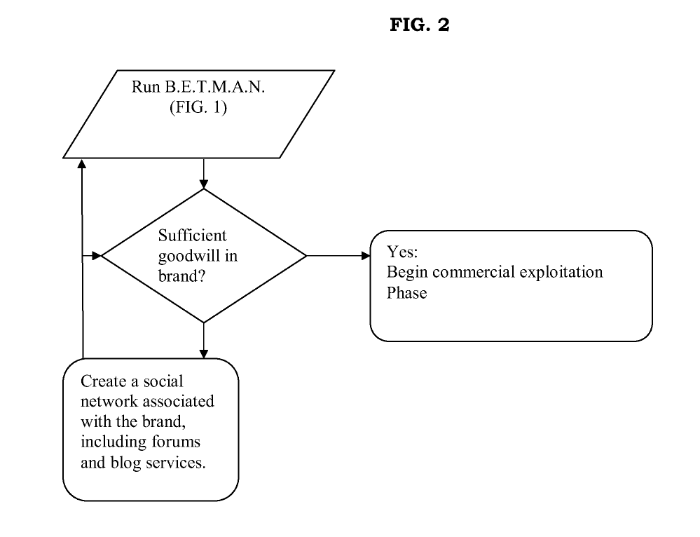

Referring to FIG. 2, it is contemplated that educational T.V., radio, and internet productions are not the only means for developing the goodwill. It is also contemplated that additionally podcasts, social networking (e.g., Facebook®), and blogs may be used to develop further good will. For example, a social network titled after a brand name and formed for those who enjoy the collection of memorabilia and antiquities might be provided with podcasts, tips, forums and the like for learning and discussing the subject hobby. However, unlike current embodiments of such devices, the present method employs a period of goodwill development where advertising is not the focus. Later, after goodwill has been developed within the social network, the members thereof and the brand might be better targeted for commercial exploitation. This technique of building brand loyalty is contrary to traditional direct methods of advertising and also serves a useful social purpose of educating the public on issues of interest.

It should be noted that FIGS. 1 and 2 and the associated description are of illustrative importance only. In other words, the depiction and descriptions of the present invention should not be construed as limiting of the subject matter in this application. The method discussed hereby is susceptible to modification without changing the overall concept of the disclosed invention. Such modifications might become apparent to one skilled in the art after reading this disclosure.

In summary, an embodiment of the present application might be a method of branding goods or services comprising the steps of: identifying goods or services; obtaining data relating to the goods or services; using the data to select a brand name; transforming the data into an educational production that does not feature advertising; sharing the educational production under the brand name to develop goodwill; and, commercially exploiting the goodwill. The identified method could also comprise the step of protecting said brand name by registering it with governmental authorities. Within the method said education production may be of any of the groups of media productions consisting essentially of either radio, television, podcasts, social networking sites, broadcasts to cell phones, or internet broadcasts. Also within the method the step of commercially exploiting the goodwill of said brand may be accomplished by: conducting online auctions; promotional efforts on social networking sites; live auctions; licensing of products and services bearing the brand; merchandising of products bearing the brand; promotional efforts on broadcasts of any of the groups consisting essentially of radio, television, internet, podcasts, or phonecasts. Furthermore, within the method the data might be regarding whether and how the goods and services relate to a social service or ideology.

Another embodiment of the present application might be method of commercially exploiting goodwill of a brand name for goods or services wherein the goodwill was created via the sharing of an educational production without direct advertising, the method comprising the steps of: identifying a general purpose computer; and providing the general purpose computer with programming for (1) establishing a database of individuals who have shared the educational production, and (2) presenting at least one of the individuals recorded in the database with an opportunity to purchase the goods or services, and (3) recording any orders for the goods or services.

It should be noted that theh above description is of illustrative importance only. In other words, the descriptions of the present application should not be construed as limiting of the subject matter in this application. The apparatus and methods discussed hereby are susceptible to modification without changing the overall concept of the disclosure. It should also be noted that what is disclosed may be termed, B.E.T.M.A.N. Branding Model since what is disclosed may be a method of Branding through Educational Television Marketing and Networking.

I claim:

1. A method of branding goods or services comprising the steps of:
identifying and item of goods or services;
obtaining data relating to the items of goods or services;
using the data to select a brand name to be used in connection with the item;
transforming the data into an educational production that does not feature advertising;
sharing the educational production that features the brand name as its title to develop goodwill in the brand name; and,
exploiting the goodwill to sell the item.

2. The method of claim 1 further comprising the step of protecting said brand name by registering it with governmental authorities.

3. The method of claim 1 wherein said education production may be selected from the group consisting essentially of media productions consisting essentially of either radio, television, podcasts, social networking sites, broadcasts to cell phones, or internet broadcasts.

4. The method of claim 1 wherein the step of commercially exploiting the goodwill is accomplished by conducting online auctions to sell the item.

5. The method of claim 1 wherein the step of commercially exploiting the goodwill is accomplished by promotional efforts on social networking sites to sell the item.

6. The method of claim 1 wherein the step of commercially exploiting the goodwill is accomplished by conducting live auctions to sell the item.

7. The method of claim 1 wherein the step of commercially exploiting the goodwill is accomplished by licensing of products and services bearing the brand.

8. The method of claim 1 wherein the step of commercially exploiting the goodwill is accomplished by merchandising of products bearing the brand.

9. The method of claim 1 wherein the step of commercially exploiting the goodwill is accomplished by promotional efforts on broadcasts of any of the groups consisting essentially of radio, television, internet, podcasts, or phonecasts to sell the item.

10. A method of branding goods or services comprising the steps of:
identifying and item of goods or services;
obtaining data relating to the items of goods or services;
producing an educational production about the item that does not feature advertising;
sharing the educational production under the brand name to develop goodwill; and,
commercially exploiting the goodwill.

11. The method of claim 10 further comprising the step of protecting said brand name by registering it with governmental authorities.

12. The method of claim 10 wherein said education production may be selected from the group consisting essentially of media productions consisting essentially of either radio, television, podcasts, social networking sites, broadcasts to cell phones, or internet broadcasts.

13. The method of claim 10 wherein the step of commercially exploiting the goodwill is accomplished by conducting online auctions to sell the item.

14. The method of claim 10 wherein the step of commercially exploiting the goodwill is accomplished by promotional efforts on social networking sites to sell the item.

15. The method of claim 10 wherein the step of commercially exploiting the goodwill is accomplished by conducting live auctions to sell the item.

16. The method of claim 10 wherein the step of commercially exploiting the goodwill is accomplished by licensing of products and services bearing the brand.

17. The method of claim 10 wherein the step of commercially exploiting the goodwill is accomplished by merchandising of products bearing the brand.

18. The method of claim 10 wherein the step of commercially exploiting the goodwill is accomplished by promotional efforts on broadcasts of any of the groups consisting essentially of radio, television, internet, podcasts, or phonecasts to sell the item.

19. The method of claim 10 wherein the educational program presents information about whether and how the items relates to a social service or ideology.

20. A method of commercially exploiting goodwill of a brand name for an item of goods or services wherein the goodwill was created via the sharing of an educational production without direct advertising, the method comprising the steps of:
identifying a general purpose computer; and
providing the general purpose computer with programming
(1) establishing a database of individuals who have observed the educational production,
(2) presenting at least one of the individuals recorded in the database with an opportunity to purchase the goods or services, and
(3) recording any orders for the goods or services.
